(19) United States
(12) Patent Application Publication
(10) Pub. No.: US 2014/0098893 A1
(43) Pub. Date: Apr. 10, 2014

(54) DATA PROCESSING APPARATUS FOR CONFIGURING DISPLAY INTERFACE BASED ON COMPRESSION CHARACTERISTIC OF COMPRESSED DISPLAY DATA AND RELATED DATA PROCESSING METHOD

(71) Applicant: MEDIATEK INC., Hsin-Chu (TW)

(72) Inventors: Chi-Cheng Ju, Hsinchu City (TW); Tsu-Ming Liu, Hsinchu City (TW)

(21) Appl. No.: 13/937,224

(22) Filed: Jul. 9, 2013

Related U.S. Application Data
(60) Provisional application No. 61/711,319, filed on Oct. 9, 2012.

(51) Int. Cl. H04N 7/26

(52) U.S. Cl. CPC H04N 19/00903
USPC 375/240.26

(57) ABSTRACT

A data processing apparatus at a transmitter end has an output interface and a display controller. The output interface packs a compressed display data into an output bitstream, and outputs the output bitstream via a display interface. The display controller refers to a compression characteristic of the compressed display data to configure a transmission setting of the output interface over the display interface (e.g., number of data lines, operating frequency of each data line, and/or behavior in the blanking period). A data processing apparatus at a receiver end has an input interface and a controller. The input interface receives an input bitstream via a display interface, and un-packs the input bitstream into a compressed display data that is transmitted over the display interface. The controller configures a reception setting of the input interface over the display interface in response to a compression characteristic of the compressed display data.

### CROSS REFERENCE TO RELATED APPLICATIONS

This application claims the benefit of U.S. provisional application No. 61/711,319, filed on Oct. 9, 2012 and incorporated herein by reference.

### BACKGROUND

The disclosed embodiments of the present invention relate to transmitting and receiving display data over a display interface, and more particularly, to a data processing apparatus for configuring a display interface based on a compression characteristic of a compressed display data and related data processing method.

A display interface is disposed between a first chip and a second chip to transmit display data from the first chip to the second chip for further processing. For example, the first chip may be a host application processor, and the second chip may be a driver integrated circuit (IC). The display data may include image data, video data, graphic data, and/or OSD (on-screen display) data. Besides, the display data may be single view data for two-dimensional (2D) display or multiple view data for three-dimensional (3D) display. When a display panel supports a higher display resolution, 2D/3D display with higher resolution can be realized. Hence, the display data transmitted over the display interface would have a larger data size/data rate, which increases the power consumption of the display interface inevitably. If the host application processor and the driver IC are both located at a portable device (e.g., a smartphone) powered by a battery device, the battery life is shortened due to the increased power consumption of the display interface. Thus, there is a need for an innovative design which can effectively reduce the power consumption of the display interface.

### SUMMARY

In accordance with exemplary embodiments of the present invention, a data processing apparatus for configuring a display interface based on a compression characteristic of a compressed display data and related data processing method are proposed.

According to a first aspect of the present invention, an exemplary data processing apparatus is disclosed. The exemplary data processing apparatus includes an output interface and a display controller. The output interface is arranged for packing a compressed display data into an output bitstream and outputting the output bitstream via a display interface. The display controller is arranged for referring to at least a compression characteristic of the compressed display data to configure a transmission setting of the output interface over the display interface.

According to a second aspect of the present invention, an exemplary data processing apparatus is disclosed. The exemplary data processing apparatus includes an input interface and a controller. The input interface is arranged for receiving an input bitstream via a display interface, and un-packing the input bitstream into a compressed display data that is transmitted over the display interface. The controller is arranged for configuring a reception setting of the input interface over the display interface in response to at least a compression characteristic of the compressed display data.

According to a third aspect of the present invention, an exemplary data processing method is disclosed. The exemplary data processing method includes following steps: referring to at least a compression characteristic of a compressed display data to configure a transmission setting of an output interface over the display interface; and utilizing an output interface for packing the compressed display data into an output bitstream and outputting the output bitstream via the display interface.

According to a fourth aspect of the present invention, an exemplary data processing method is disclosed. The exemplary data processing method includes the following steps: configuring a reception setting of an input interface over a display interface in response to at least a compression characteristic of a compressed display data; and utilizing an input interface for receiving an input bitstream via the display interface, and un-packing the input bitstream into the compressed display data that is transmitted over the display interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a data processing system according to an embodiment of the present invention.

FIG. 2 is a flowchart illustrating a first control and data flow of the data processing system shown in FIG. 1.

FIG. 3 is a flowchart illustrating a second control and data flow of the data processing system shown in FIG. 1.

FIG. 4 is a diagram illustrating the change of the blanking period after the interface compression is applied.

FIG. 5 is a flowchart illustrating a third control and data flow of the data processing system shown in FIG. 1.

FIG. 6 is a flowchart illustrating a method of setting the application processor by referring to a result of checking a de-compression capability of the driver IC according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The present invention proposes applying data compression to a display data and then transmitting a compressed display data over a display interface. As the data size/data rate of the compressed display data is smaller than that of the original un-compressed display data, the power consumption of the display interface is reduced correspondingly. Besides, as the compressed display data requires a smaller occupied bandwidth, the present invention further proposes configuring the display interface based on the compression characteristic of the compressed display data. Further details will be described as below.

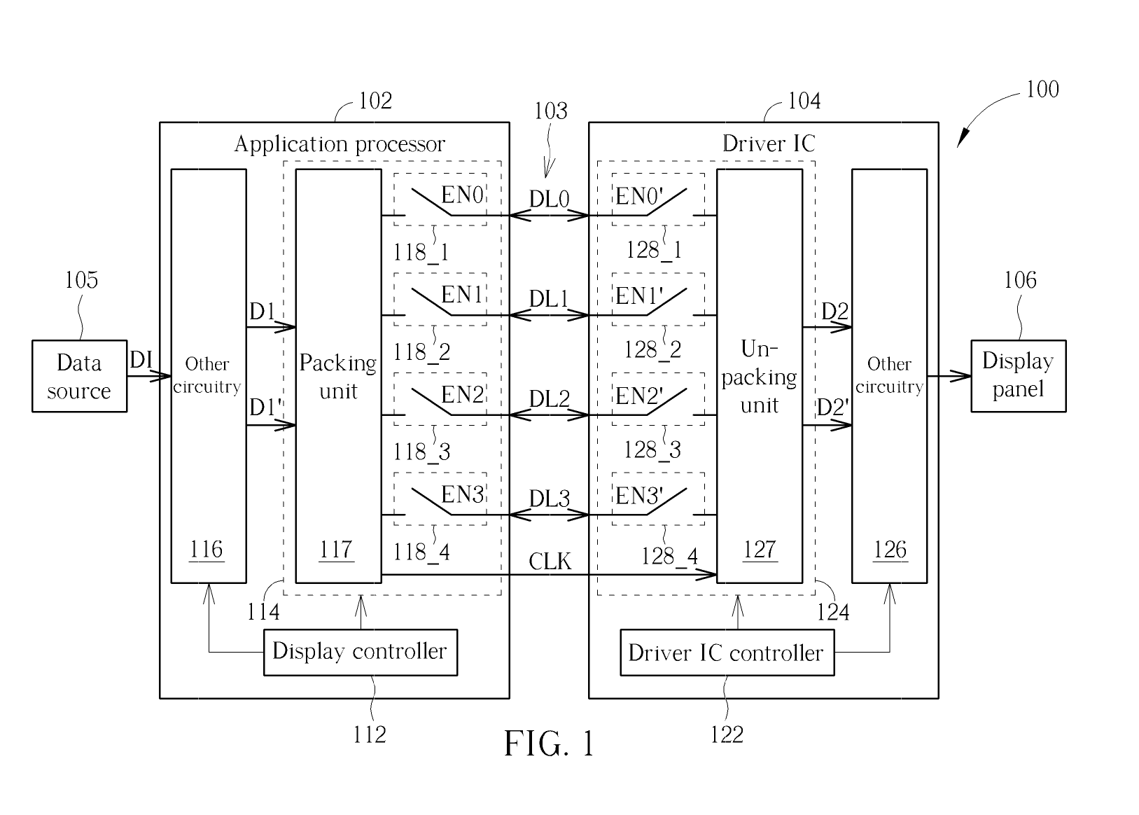

FIG. 1 is a block diagram illustrating a data processing system according to an embodiment of the present invention. The data processing system 100 includes a plurality of data processing apparatuses such as an application processor 102 and a driver integrated circuit (IC) 104. The application processor 102 and the driver IC 104 may be different chips, and the application processor 102 communicates with the driver IC 104 via a display interface 103 having a plurality of data lines (e.g., DL0, DL1, DL2, and DL3) (for example, differential pair, a pin or group of pins) and one clock line CLK. It should be noted that the number of data lines shown in FIG. 1 is for illustrative purposes only, and is not meant to be a limitation of the present invention. In this embodiment, the display interface 103 may be a display serial interface (DSI) standardized by a Mobile Industry Processor Interface (MIPI) or an embedded display port (eDP) standardized by a Video Electronics Standards Association (VESA).

The application processor 102 supports un-compressed data transmission and compressed data transmission. When the application processor 102 is used to transmit un-compressed data to the driver IC 104, the application processor 102 generates the un-compressed display data D1 according to an input display data DI provided by an external data source 105, and transmits the un-compressed display data D1 over the display interface 103. When the application processor 102 is used to transmit compressed data to the driver IC 104, the application processor 102 generates a compressed display data D1′ according to the input display data DI provided by the external data source 105, and transmits the compressed display data D1′ over the display interface 103. By way of example, but not limitation, the data source 105 may be a camera sensor, a memory card or a wireless receiver, and the input display data DI may include image data, video data, graphic data, and/or OSD data. Further, the input display data DI may be single view data for 2D display or multiple view data for 3D display.

As shown in FIG. 1, the application processor 102 includes a display controller 112, an output interface 114 and other circuitry 116. The other circuitry 116 includes circuit elements required for processing the input display data DI to generate the un-compressed data D1 or the compressed data D1′. For example, the other circuitry 116 may have a display processor, a compressor, a multiplexer, etc. The display processor performs image processing operations, including scaling, rotating, etc. The compressor performs data compression. The multiplexer receives the un-compressed display data D1 and the compressed display data D1′, and selectively outputs the un-compressed display data D1 or the compressed display data D1′ according to the operation mode of the application processor 102. For example, when the application processor 102 is operated under a compression mode, the multiplexer outputs the compressed display data D1′; and when the application processor 102 is operated under a non-compression mode, the multiplexer outputs the un-compressed display data D1. As the present invention focuses on the control of the output interface 114, further description of the other circuitry 116 is omitted here for brevity.

The output interface 114 includes a packing unit 117 and a plurality of switches (e.g., 118_1, 118_2, 118_3 and 118_4). It should be noted that the number of the switches included in the output interface 114 is equal to the number of data lines included in the display interface 103. Hence, each of the switches 118_1-118_4 controls whether a data line is used for data transmission. In this embodiment, the switches 118_1-118_4 are controlled by a plurality of enable signals EN0-EN3 generated from the display controller 112, respectively. When an enable signal has a first logic value (e.g., ‘1’), a corresponding switch is enabled (i.e., switched on) to enable the data transmission over the corresponding data line; and when the enable signal has a second logic value (e.g., ‘0’), the corresponding switch is disabled (i.e., switched off) to disable the data transmission over the corresponding data line.

Regarding the driver IC 104, it communicates with the application processor 102 via the display interface 103. In this embodiment, the driver IC 104 supports un-compressed data reception and compressed data reception. When the application processor 102 transmits the un-compressed data D1 to the driver IC 104, the driver IC 104 is operated under a non-decompression mode to receive an un-compressed data D2 from the display interface 103 and drive a display panel 106 according to the un-compressed display data D2. By way of example, the display panel 106 may be implemented using any 2D/3D display device (e.g. a retina display), and the pixel arrangement may be a rectangle layout, a triangle layout or a pentile layout. When the application processor 102 transmits the compressed data D1′ to the driver IC 104, the driver IC 104 is operated under a de-compression mode to receive a compressed display data D2′ from the display interface 103 and drive the display panel 106 according to a de-compressed display data derived from de-compressing the compressed display data D2′. If there is no error introduced during the data transmission, the un-compressed data D1 transmitted under the non-compression mode should be identical to the un-compressed data D2 received under the non-decompression mode, and the compressed data D1′ transmitted under the compression mode should be identical to the compressed data D2′ received under the de-compression mode.

As shown in FIG. 1, the driver IC 104 includes a driver IC controller 122, an input interface 124 and other circuitry 126. The other circuitry 126 may include circuit elements required for driving the display panel 106 according to a video mode or an image/command mode. For example, the other circuitry 126 may have a de-compressor, a display buffer, multiplexers, etc. The de-compressor is used for performing data de-compression to obtain a de-compressed display data. The display buffer is arranged for storing a display data which is an un-compressed display data, a compressed display data or a de-compressed display data, depending upon actual design consideration/requirement. The multiplexers control interconnections of the de-compressor, the display buffer and the display panel 106. As the present invention focuses on the control of the input interface 124, further description of the other circuitry 126 is omitted here for brevity.

The input interface 124 includes an un-packing unit 127 and a plurality of switches (e.g., 128_1, 128_2, 128_3 and 128_4). It should be noted that the number of the switches included in the input interface 124 is equal to the number of data lines included in the display interface 103. Hence, each of the switches 128_1-128_4 controls whether a data line is used for data reception. In this embodiment, the switches 128_1-128_4 are controlled by a plurality of enable signals EN0′-EN3′ generated from the driver IC controller 122, respectively. When an enable signal has a first logic value (e.g., ‘1’), a corresponding switch is enabled (i.e., switched on) to enable the data reception over the corresponding data line; and when the enable signal has a second logic value (e.g., ‘0’), the corresponding switch is disabled (i.e., switched off) to disable the data reception over the corresponding data line. It should be noted that, to make the data successfully transmitted from the application processor 102 and received by the driver IC 104, switches located at different ends of one data line of the display interface 103 should be both enabled. Further details of controlling the output interface 114 of the application processor 102 and the input interface 124 of the driver IC 104 are described as below.

When the non-compression mode of the application processor 102 is enabled, the display controller 112 controls the other circuitry 116 to generate the un-compressed display data D1 to the output interface 114, and controls the output interface 114 to use all of the data lines DL0-DL3, each having a predetermined operating frequency, for data transmission. The predetermined operating frequency (i.e., a bit clock rate per line) may be set by using the following equations.

$$\begin{matrix}Pixel Rate ( Mhz ) = \frac{Frame Resolution \times Frame Rate \times ( 1 + \% of Blanking )}{{10}^{6}} & ( 1 ) \\ Bit Clock Rate per Line = \frac{Pixel Rate \times Bits per Pixel}{Number of Data Lines} & ( 2 )\end{matrix}$$

For example, considering a 1080p full-HD video at 60 fps (frames per second) with 30% of blanking overhead, the pixel rate equals 161 MHz. When RGB 24-bit color per pixel is transmitted over 4 data lines, the bit clock rate per line reaches 970 Mbps.

Besides, when the non-decompression mode of the driver IC 104 is enabled, the driver IC controller 122 controls the input interface 124 to use all of the data lines DL0-DL3, each having the predetermined operating frequency, for data reception, and controls the other circuitry 126 to drive the display panel 106 based on the un-compressed display data D2.

Regarding the output interface 114, the packing unit 117 is arranged for packing/packetizing the un-compressed display data D1 based on the transmission protocol of the display interface 103 and accordingly generating an output bitstream to the display interface 103, wherein all of the switches 118_1-118_4 are enabled (i.e., switched on), and each data line is operated under the predetermined operating frequency (e.g., 970 Mbps) determined according to above equations. In other words, the output interface 114 has a transmission setting for packing/packetizing the un-compressed display data D1 into an output bitstream and outputting the output bitstream via the display interface 103.

Regarding the input interface 124, the un-packing unit 117 is arranged for un-packing/un-packetizing an input bitstream based on the transmission protocol of the display interface 103 and accordingly generating the un-compressed display data D2 to the other circuitry 126, wherein all of the switches 128_1-128_4 are enabled (i.e., switched on), and each data line is operated under the predetermined operating frequency (e.g., 970 Mbps) determined according to above equations. In other words, the input interface 124 has a reception setting for receiving an input bitstream via the display interface 103 and un-packing/un-packetizing the input bitstream into the un-compressed display data D1 that is transmitted over the display interface 103.

In general, the aforementioned un-compressed data transmission is exploited and standardized by MIPI's DSI and VESA's eDP. However, it may not afford the high data rate, and may have potential problems in high power dissipation and low design yield. To alleviate the aforementioned problems, the other circuitry 116 in the application processor 102 is configured to have a compressor implemented therein, and the other circuitry 126 in the driver IC 104 is configured to have a de-compressor implemented therein. Hence, the compressed data transmission over the display interface 103 is realized through the compressor and the de-compressor.

When the compression mode of the application processor 102 is enabled, the display controller 112 controls the other circuitry 116 to generate the compressed display data D1′ to the output interface 114, wherein the compressor implemented in the other circuitry 116 may employ a lossy or lossless compression algorithm, depending upon actual design consideration/requirement. Regarding the output interface 114, the packing unit 117 packs/packetizes the compressed display data D1′ based on the transmission protocol of the display interface 103 and accordingly generates an output bitstream to the display interface 103. In other words, when the application processor 102 is operated under the compression mode, the output interface 114 is arranged for packing/packetizing the compressed display data D1′ into an output bitstream and outputting the output bitstream via the display interface 103.

When the de-compression mode of the driver IC 104 is enabled, the driver IC controller 122 controls the other circuitry 126 to drive the display panel 106 based on the compressed display data D2′, wherein the de-compressor implemented in the other circuitry 126 may employ a lossy or lossless de-compression algorithm, depending upon actual design consideration/requirement. Regarding the input interface 124, the un-packing unit 127 un-packs/un-packetizes the input bitstream into the compressed display data D2′ based on the transmission protocol of the display interface 103. In other words, when the driver IC 104 is operated under the de-compression mode, the input interface 124 is arranged for receiving an input bitstream via the display interface 103, and un-packing/un-packetizing the input bitstream into the compressed display data D2′ that is transmitted over the display interface 103.

As the data size of the compressed display data is smaller than that of the original un-compressed display data, the output interface 114 is controlled by the display controller 112 to have a different transmission setting, and the input interface 124 of the driver IC 104 is controlled by the driver IC controller 122 to have a different reception setting. In this embodiment of the present invention, the display interface 103 provides a data line management layer and is scalable to the number of data lines according to the bandwidth and the compression requirement. The display controller 112 is therefore arranged for referring to at least a compression characteristic of the compressed display data D1′ to configure a transmission setting of the output interface 114 over the display interface 103, and the driver IC controller 122 is arranged for configuring a reception setting of the input interface 124 over the display interface 103 in response to at least the compression characteristic of the compressed display data D1′.

By way of example, but not limitation, the aforementioned compression characteristic may be a compression ratio M corresponding to the compressed display data D1′, where M≦1.0. The compression ratio M may be expressed using the following equation.

$$M = \frac{amount of compressed data}{amount of un \text{-} compressed data} \qquad ( 3 )$$

Take 4×2 RGB888 pixels as an example, the amount of un-compressed data reaches 192 bits (i.e., 4×2×24 bits). When the compression ratio M is equal 0.5, the compressed data would have 96 bits. As the data amount to be transmitted is reduced by data compression with the compression ratio M smaller than 1, the number of data lines, the operating frequency of each data line, and/or the behavior in the blanking period may be adjusted to improve the overall system performance.

In a first exemplary design, each of the display controller 112 and the driver IC controller 122 refers to the compression ratio M to configure the number of data lines enabled over the display interface 103 for data transmission and reception when the application processor 102 is used to transmit the compressed display data D1′ to the driver IC 104, wherein an operating frequency of each data line (i.e., a bit clock rate of each data line) remains unchanged regardless of the configured number of data lines. As the data compression is performed on the application processor 102, the application processor 102 may inform the driver IC 104 of the compression ratio M corresponding to the compressed display data D1′. Suppose that all of the data lines DL0-DL3, each having the predetermined operating frequency, will be used for transmitting the un-compressed display data D1. Thus, when the non-compression mode of the application processor 102 is enabled and the non-decompression mode of the driver IC 104 is enabled, the display controller 112 sets each of the enable signals EN0-EN3 by the first logic value (e.g., ‘1’) such that all of the switches 118_1-118_4 are enabled (i.e., switched on), and the driver IC controller 122 sets each of the enable signals EN0′-EN3′ by the first logic value (e.g., ‘1’) such that all of the switches 128_1-128_4 are enabled (i.e., switched on). However, when the compression mode of the application processor 102 is enabled and the de-compression mode of the driver IC 104 is enabled, the number of data lines enabled over the display interface 103 is set to a value equal to a product of the number of data lines DL0-DL3 (i.e., the number of data lines without compression) and the compression ratio M. For example, if M=0.5 and the number of data lines without compression is 4, the number of data lines with compression is equal to 2. As the number of data lines is reduced to 2, the display controller 112 may set two of four enable signals (e.g., EN0 and EN1) by the first logic value (e.g., ‘1’) and set the remaining enable signals (e.g., EN2 and EN3) by the second logic value (e.g., ‘0’), and the driver IC controller 122 may set two of four enable signals (e.g., EN0′ and EN1′) by the first logic value (e.g., ‘1’) and set the remaining enable signals (e.g., EN2′ and EN3′) by the second logic value (e.g., ‘0’). Thus, only a portion of the switches 118_1-118_4 are enabled (i.e., switched on) by the display controller 112, and only a portion of the switches 128_1-128_4 are enabled (i.e., switched on) by the driver IC controller 122. To put it simply, the bandwidth can be reduced by the interface compression, and the reduced number of data lines is related to the compression ratio M. Besides, due to the reduced number of data lines enabled over the display interface 103, the transmission power dissipation and electromagnetic interference (EMI) can be alleviated.

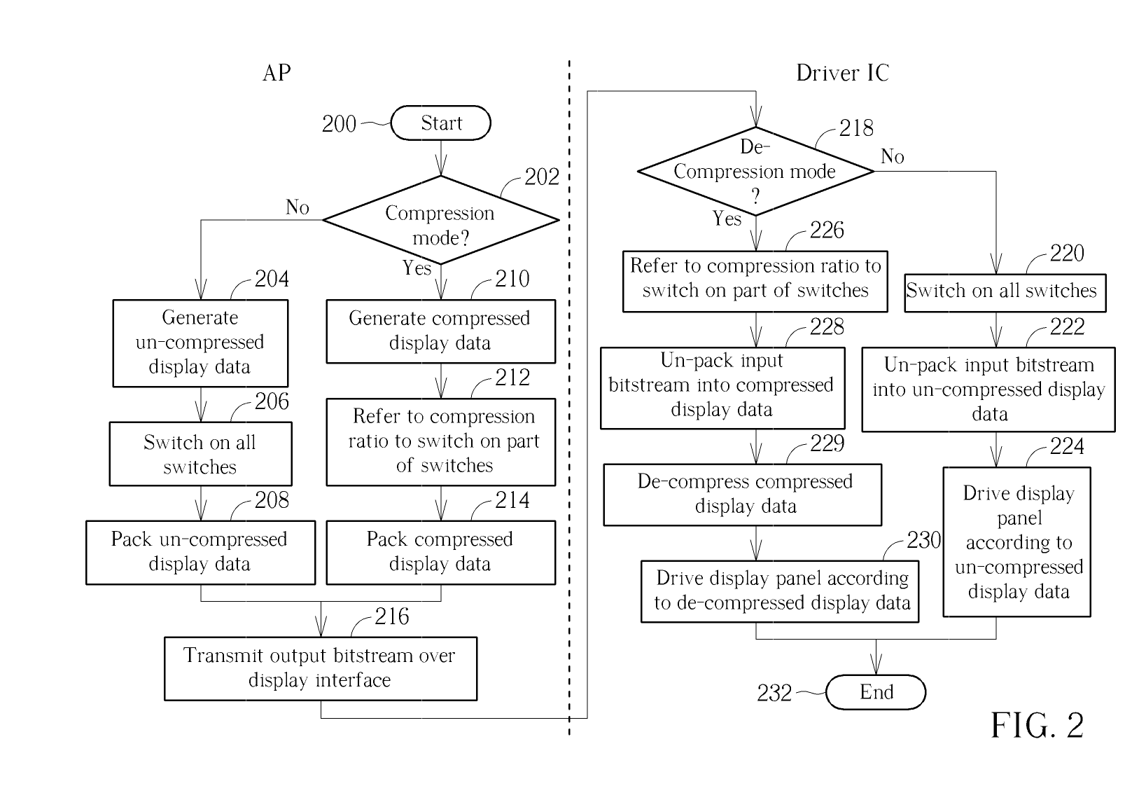

Please refer to FIG. 2, which is a flowchart illustrating a first control and data flow of the data processing system 100 shown in FIG. 1. In this embodiment, the compression ratio M is referenced to configure the number of data lines enabled over the display interface 103, and the operating frequency of each data line remains unchanged. Provided that the result is substantially the same, the steps are not required to be executed in the exact order shown in FIG. 2. The exemplary first control and data flow may be briefly summarized by following steps.

Step 200: Start.

Step 202: Check if a compression mode is enabled. If yes, go to step 210; otherwise, go to step 204.

Step 204: The other circuitry 116 generates the un-compressed display data D1 according to the input display data DI.

Step 206: The display controller 112 controls the output interface 114 to switch on all of the switches 118_1-118_4. In this way, all of the data lines DL0-DL3 of the display interface 103 would be used by the application processor 102 for data transmission.

Step 208: The packing unit 117 directly packs/packetizes the un-compressed display data D1 into an output bitstream. Go to step 216.

Step 210: The other circuitry 116 generates the compressed display data D1′ according to the input display data DI.

Step 212: The display controller 112 refers to the compression ratio M corresponding to the compressed display data D1′ to switch on a portion of the switches 118_1-118_4. In this way, only part of the data lines DL0-DL3 of the display interface 103 would be used by the application processor 102 for data transmission.

Step 214: The packing unit 117 packs/packetizes the compressed display data D1′ into an output bitstream.

Step 216: Transmit the output bitstream over the display interface 103.

Step 218: Check if a de-compression mode is enabled. If yes, go to step 226; otherwise, go to step 220.

Step 220: The driver IC controller 122 controls the input interface 124 to switch on all of the switches 128_1-128_4. In this way, all of the data lines DL0-DL3 of the display interface 103 would be used by the driver IC 104 for data reception.

Step 222: The un-packing unit 127 un-packs/un-packetizes an input bitstream into the un-compressed display data D2.

Step 224: The other circuitry 126 drives the display panel 106 according to the un-compressed display data D2. Go to step 232.

Strep 226: The driver IC controller 122 refers to the compression ratio M corresponding to the compressed display data D1′ to switch on a portion of the switches 128_1 -128_4. In this way, only part of the data lines DL0-DL3 of the display interface 103 would be used by the driver IC 104 for data reception.

Step 228: The un-packing unit 127 un-packs/un-packetizes the input bitstream into the compressed display data D2′.

Step 229: The other circuitry 126 derives a de-compressed display data from de-compressing the compressed display data D2′.

Step 230: The other circuitry 126 drives the display panel 106 according to the de-compressed display data.

Step 232: End.

It should be noted that steps 202-216 are performed by the application processor 102, and steps 218-230 are performed by the driver IC 104. As a person skilled in the art can readily understand details of each step shown in FIG. 2 after reading above paragraphs, further description is omitted here for brevity.

In a second exemplary design, each of the display controller 112 and the driver IC controller 122 refers to the compression ratio M to configure an operating frequency of each data line (i.e., a bit clock rate of each data line) when the application processor 102 is used to transmit the compressed display data D1′ to the driver IC 104, wherein the number of data lines enabled over the display interface 103 remains unchanged regardless of the configured operating frequency. As the data compression is performed on the application processor 102, the application processor 102 may inform the driver IC 104 of the compression ratio M corresponding to the compressed display data D1′. Suppose that all of the data lines DL0-DL3, each having the predetermined operating frequency, will be used for transmitting the un-compressed display data D1. Thus, when the non-compression mode of the application processor 102 is enabled and the non-decompression mode of the driver IC 104 is enabled, each of the data lines DL0-DL3 is controlled to operate under the predetermined operating frequency, wherein all of the switches 118_1-118_4 are enabled (i.e., switched on) by the display controller 112, and all of the switches 128_1-128_4 are enabled (i.e., switched on) by the driver IC controller 122. However, when the compression mode of the application processor 102 is enabled and the de-compression mode of the driver IC 104 is enabled, the operating frequency of each data line is set by a value equal to a product of the predetermined operating frequency (i.e., a non-compression/non-decompression mode bit clock rate) and the compression ratio M. Thus, the compressed display data D1′ is transmitted at a lower clock rate under the condition where the number of data lines enabled over the display interface 103 remains unchanged. For example, if M=0.5, the compression/de-compression mode bit clock rate is half of the non-compression/non-decompression mode bit clock rate. In one exemplary implementation, the required clock frequency selection may be implemented using different clock generators which supply clocks with different clock rates. However, this is for illustrative purposes only, and is not meant to be a limitation of the present invention. To put it simply, the bandwidth can be reduced by the interface compression, and the reduced operating frequency is related to the compression ratio M. Besides, due to the reduced operating frequency of each data line enabled over the display interface 103, the transmission power dissipation and EMI can be alleviated.

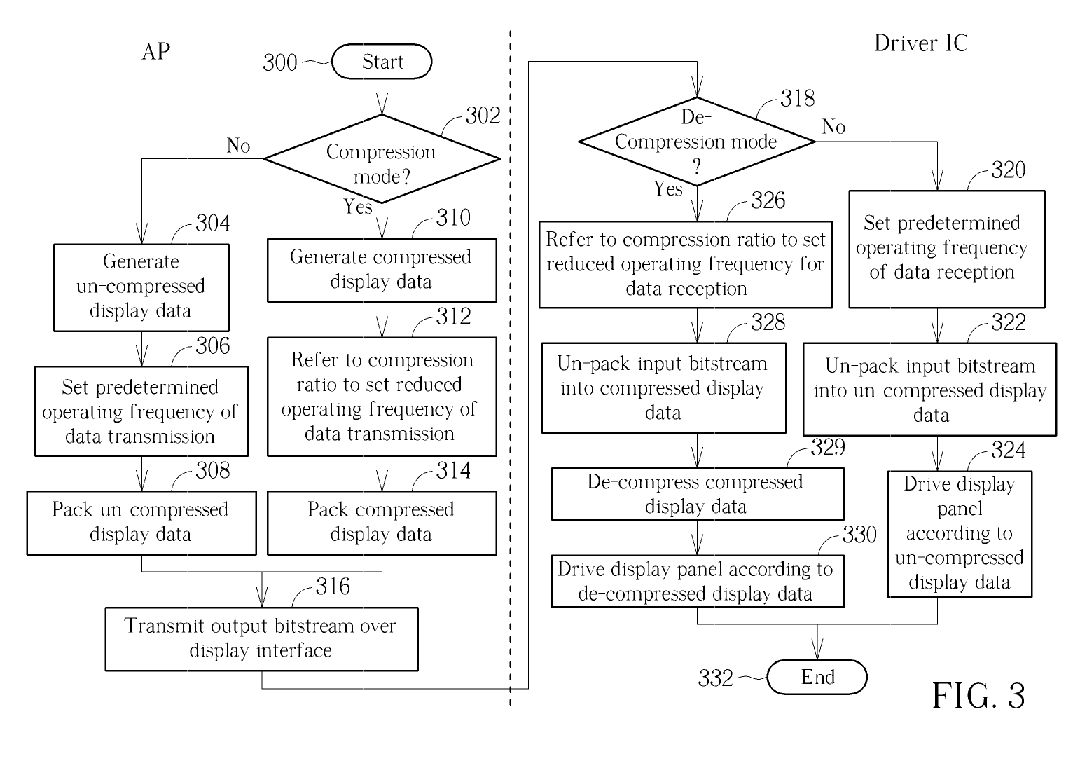

Please refer to FIG. 3, which is a flowchart illustrating a second control and data flow of the data processing system 100 shown in FIG. 1. In this embodiment, the compression ratio M is referenced to configure the operating frequency of each data line, and the number of data lines enabled over the display interface 103 remains unchanged. Provided that the result is substantially the same, the steps are not required to be executed in the exact order shown in FIG. 3. The exemplary second control and data flow may be briefly summarized by following steps.

Step 300: Start.

Step 302: Check if a compression mode is enabled. If yes, go to step 310; otherwise, go to step 304.

Step 304: The other circuitry 116 generates the un-compressed display data D1 according to the input display data DI.

Step 306: The display controller 112 controls the output interface 114 to set a predetermined operating frequency of data transmission on each data line.

Step 308: The packing unit 117 directly packs/packetizes the un-compressed display data D1 into an output bitstream. Go to step 316.

Step 310: The other circuitry 116 generates the compressed display data D1′ according to the input display data DI.

Step 312: The display controller 112 refers to the compression ratio M corresponding to the compressed display data D1′ to set a reduced operating frequency of data transmission on each data line.

Step 314: The packing unit 117 packs/packetizes the compressed display data D1′ into an output bitstream.

Step 316: Transmit the output bitstream over the display interface 103.

Step 318: Check if a de-compression mode is enabled. If yes, go to step 326; otherwise, go to step 320.

Step 320: The driver IC controller 122 controls the input interface 124 to set a predetermined operating frequency of data reception on each data line.

Step 322: The un-packing unit 127 un-packs/un-packetizes an input bitstream into the un-compressed display data D2.

Step 324: The other circuitry 126 drives the display panel 106 according to the un-compressed display data D2. Go to step 332.

Strep 326: The driver IC controller 122 refers to the compression ratio M corresponding to the compressed display data D1′ to set a reduced operating frequency for data reception on each data line.

Step 328: The un-packing unit 127 un-packs/un-packetizes the input bitstream into the compressed display data D2′.

Step 329: The other circuitry 126 derives a de-compressed display data from de-compressing the compressed display data D2′.

Step 330: The other circuitry 126 drives the display panel 106 according to the de-compressed display data.

Step 332: End.

It should be noted that steps 302-316 are performed by the application processor 102, and steps 318-330 are performed by the driver IC 104. As a person skilled in the art can readily understand details of each step shown in FIG. 3 after reading above paragraphs, further description is omitted here for brevity.

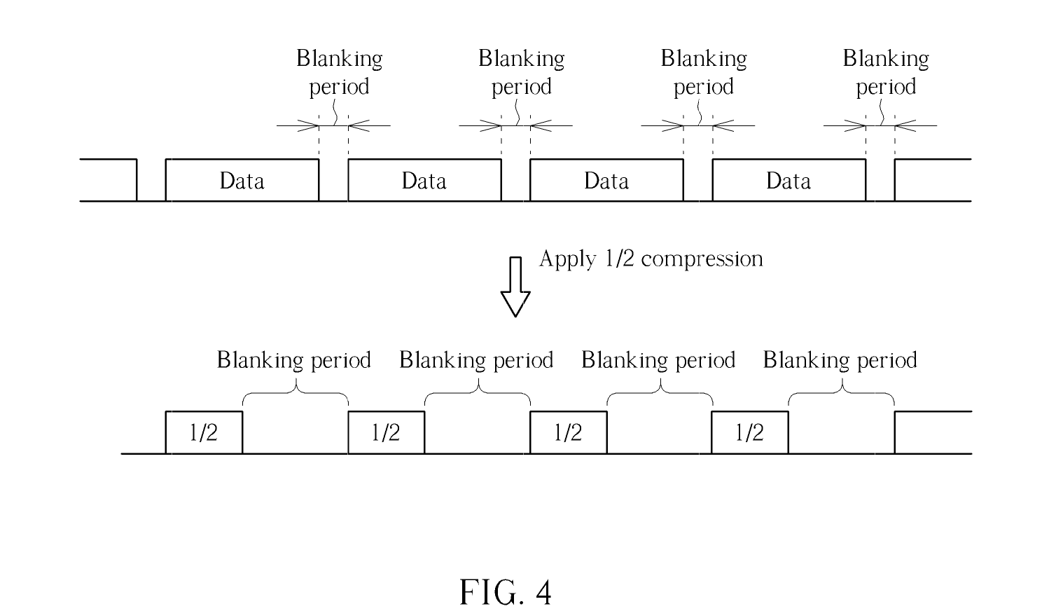

In a third exemplary design, when a compression mode of the application processor 102 is enabled and a de-compression mode of the driver IC 104 is enabled, the display controller 112 refers to the compression ratio M to configure a behavior of the output interface 114 during a blanking period between adjacent data transmissions, and the driver IC controller 122 refers to the compression ratio M to configure a behavior of the input interface 124 during a blanking period between adjacent data transmissions, wherein the number of data lines enabled over the display interface 103 and the operating frequency of each data line remain unchanged regardless of the configured behavior of the output interface 114 and the configured behavior of the input interface 124. Please refer to FIG. 4, which is a diagram illustrating the change of the blanking period after the interface compression is applied. When no interface compression is applied (i.e., the un-compressed display data D1 is transmitted over the display interface 103 and the un-compressed display data D2 is received from the display interface 103), the banking period is generally shorter than the data transmission period. However, when interface compression is applied (i.e., the compressed display data D1′ is transmitted over the display interface 103 and the compressed display data D2′ is received from the display interface 103), the banking period is extended due to a shorter data transmission period. In other words, as the compression ratio M is smaller than 1 (e.g., M=0.5), the interface compression is capable of creating an extra blanking period. In one exemplary design, the extra blanking period may allow negotiation between the application processor 102 and the driver IC 104 so as to alleviate electrostatic discharge (ESD), EMI and/or power consumption. For example, during the blanking period extended by the interface compression, the data transmission may be turned off and/or additional commands may be sent from the application processor 102 to the driver IC 104. To put it simply, the bandwidth can be reduced by the interface compression, and the extended blanking period is related to the compression ratio M.

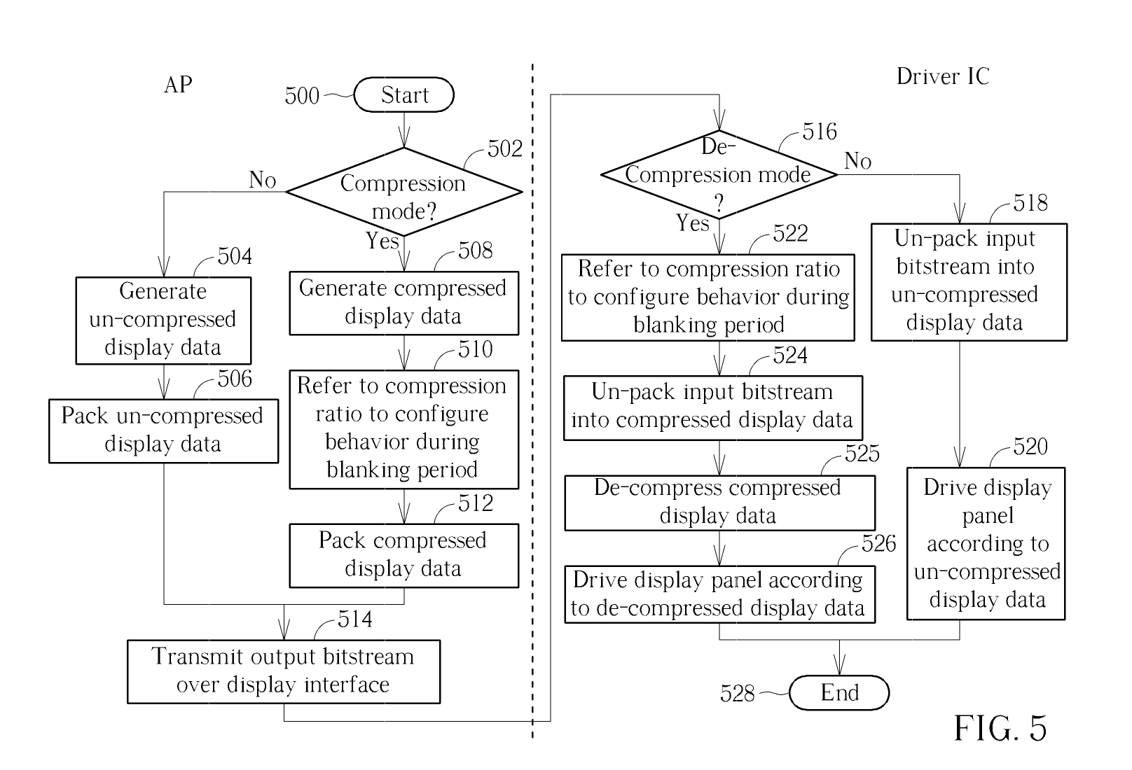

Please refer to FIG. 5, which is a flowchart illustrating a third control and data flow of the data processing system 100 shown in FIG. 1. In this embodiment, the compression ratio M is referenced to configure the behavior of the output interface 114 and the input interface 124 during the blanking period, and the number of data lines enabled over the display interface 103 and the operating frequency of each data line remain unchanged. Provided that the result is substantially the same, the steps are not required to be executed in the exact order shown in FIG. 5. The exemplary third control and data flow may be briefly summarized by following steps.

Step 500: Start.

Step 502: Check if a compression mode is enabled. If yes, go to step 508; otherwise, go to step 504.

Step 504: The other circuitry 116 generates the un-compressed display data D1 according to the input display data DI.

Step 506: The packing unit 117 directly packs/packetizes the un-compressed display data Dl into an output bitstream. Go to step 514.

Step 508: The other circuitry 116 generates the compressed display data D1′ according to the input display data DI.

Step 510: The display controller 112 refers to the compression ratio M corresponding to the compressed display data D1′ to configure the behavior of the output interface 114 during the blanking period between adjacent data transmissions.

Step 512: The packing unit 117 packs/packetizes the compressed display data D1′ into an output bitstream.

Step 514: Transmit the output bitstream over the display interface 103.

Step 516: Check if a de-compression mode is enabled. If yes, go to step 522; otherwise, go to step 518.

Step 518: The un-packing unit 127 un-packs/un-packetizes an input bitstream into the un-compressed display data D2.

Step 520: The other circuitry 126 drives the display panel 106 according to the un-compressed display data D2. Go to step 528.

Strep 522: The driver IC controller 122 refers to the compression ratio M corresponding to the compressed display data D1′ to configure the behavior of the input interface 214 during the blanking period between adjacent data transmissions.

Step 524: The un-packing unit 127 un-packs/un-packetizes the input bitstream into the compressed display data D2′.

Step 525: The other circuitry 126 derives a de-compressed display data from de-compressing the compressed display data D2′.

Step 526: The other circuitry 126 drives the display panel 106 according to the de-compressed display data.

Step 528: End.

It should be noted that steps 502-514 are performed by the application processor 102, and steps 516-526 are performed by the driver IC 104. As a person skilled in the art can readily understand details of each step shown in FIG. 5 after reading above paragraphs, further description is omitted here for brevity.

The display interface 103 may have at least one data line which is a bidirectional line. For example, the data line DL0 as shown in FIG. 1 is bidirectional. Hence, information transaction between the application processor 102 and the driver IC 104 can be realized by using the bidirectional data line DL0. In this embodiment of the present invention, the display controller 112 may further check a de-compression capability of the driver IC 104 by sending a request to the driver IC 104, and the driver IC controller 122 may further inform the application processor 102 of the de-compression capability of the driver IC 104 by sending a response to the application processor 102. In this way, the application processor 102 can detect whether the driver IC 104 has the ability of performing data de-compression, and further detect what kinds of de-compression algorithms the driver IC 104 supports if the driver IC 104 is equipped with de-compression capability. In a case where the driver IC 104 supports the interface compression, the driver IC 104 may enable the de-compression mode after transmitting the de-compression capability information in response to the request issued by the application processor 102. Next, the application processor 102 enables the compression mode according to a checking result of the de-compression capability of the driver IC 104, and configures the compressor in the other circuitry 116 to employ one of compression algorithms corresponding to de-compression algorithms supported by the driver IC 104. However, when the driver IC 104 does not support the interface compression, the driver IC 104 simply operates under the non-decompression mode, and the application processor 102 would enable the non-compression mode according to the checking result of the de-compression capability of the driver IC 104.

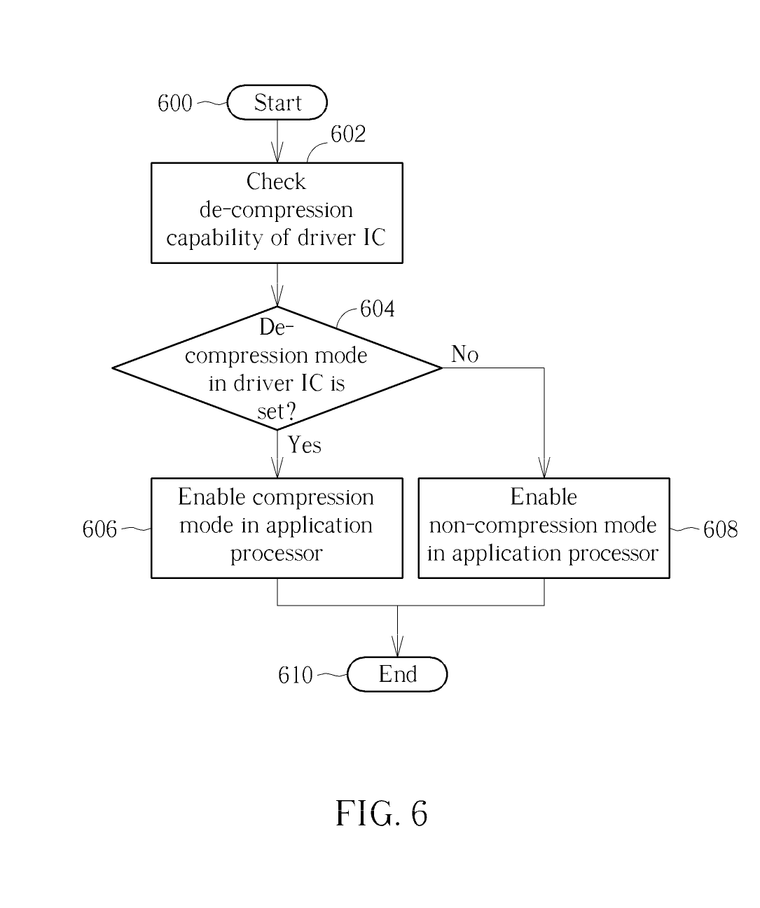

Please refer to FIG. 6, which is a flowchart illustrating a method of setting the application processor 102 by referring to a result of checking a de-compression capability of the driver IC 104 according to an embodiment of the present invention. Provided that the result is substantially the same, the steps are not required to be executed in the exact order shown in FIG. 6. The exemplary method may be briefly summarized by following steps.

Step 600: Start.

Step 602: Check a de-compression capability of the driver IC 104 to see if the driver IC 104 supports the proposed interface compression, and accordingly obtain a checking result.

Step 604: Refer to the checking result to determine if the de-compression mode in the driver IC 104 is set? If yes, go to step 606; otherwise, go to step 608.

Step 606: Enable the compression mode in the application processor 102. Go to step 610.

Step 608: Enable the non-compression mode in the application processor 102.

Step 610: End.

As a person skilled in the art can readily understand details of each step shown in FIG. 6 after reading above paragraphs, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing apparatus comprising:
an output interface, arranged for packing a compressed display data into an output bitstream and outputting the output bitstream via a display interface; and
a display controller, arranged for referring to at least a compression characteristic of the compressed display data to configure a transmission setting of the output interface over the display interface.

2. The data processing apparatus of claim 1, wherein the display interface is a display serial interface (DSI) standardized by a Mobile Industry Processor Interface (MIPI) or an embedded display port (eDP) standardized by a Video Electronics Standards Association (VESA).

3. The data processing apparatus of claim 1, wherein the compression characteristic is a compression ratio corresponding to the compressed display data.

4. The data processing apparatus of claim 1, wherein the transmission setting of the output interface comprises a number of data lines enabled over the display interface.

5. The data processing apparatus of claim 4, wherein an operating frequency of each data line remains unchanged regardless of the configured number of data lines.

6. The data processing apparatus of claim 1, wherein the transmission setting of the output interface comprises an operating frequency of each data line.

7. The data processing apparatus of claim 6, wherein a number of data lines enabled over the display interface remains unchanged regardless of the configured operating frequency.

8. The data processing apparatus of claim 1, wherein the transmission setting of the output interface comprises a behavior of the output interface during a blanking period between adjacent data transmissions.

9. The data processing apparatus of claim 8, wherein a number of data lines enabled over the display interface and an operating frequency of each data line remain unchanged regardless of the configured behavior of the output interface during the blanking period.

10. The data processing apparatus of claim 1, wherein the data processing apparatus is coupled to another data processing apparatus via the display interface; and the display controller is further arranged for checking a de-compression capability of the another data processing apparatus, where the data processing apparatus selectively enables a compression mode according to a checking result.

11. A data processing apparatus comprising:
an input interface, arranged for receiving an input bitstream via a display interface, and un-packing the input bitstream into a compressed display data that is transmitted over the display interface; and
a controller, arranged for configuring a reception setting of the input interface over the display interface in response to at least a compression characteristic of the compressed display data.

12. The data processing apparatus of claim 11, wherein the display interface is a display serial interface (DSI) standardized by a Mobile Industry Processor Interface (MIPI) or an embedded display port (eDP) standardized by a Video Electronics Standards Association (VESA).

13. The data processing apparatus of claim 11, wherein the compression characteristic is a compression ratio corresponding to the compressed display data.

14. The data processing apparatus of claim 11, wherein the reception setting of the input interface comprises a number of data lines enabled over the display interface.

15. The data processing apparatus of claim 14, wherein an operating frequency of each data line remains unchanged regardless of the configured number of data lines.

16. The data processing apparatus of claim 11, wherein the reception setting of the input interface comprises an operating frequency of each data line.

17. The data processing apparatus of claim 16, wherein a number of data lines enabled over the display interface remains unchanged regardless of the configured operating frequency.

18. The data processing apparatus of claim 11, wherein the reception setting of the input interface comprises a behavior of the input interface during a blanking period between adjacent data transmissions.

19. The data processing apparatus of claim 18, wherein a number of data lines enabled over the display interface and an operating frequency of each data line remain unchanged regardless of the configured behavior of the input interface during the blanking period.

20. The data processing apparatus of claim 11, wherein the data processing apparatus is coupled to another data processing apparatus via the display interface, and the controller is further arranged for informing the another data processing apparatus of a de-compression capability of the data processing apparatus.

21. A data processing method comprising:
referring to at least a compression characteristic of a compressed display data to configure a transmission setting of an output interface over the display interface; and
utilizing an output interface for packing the compressed display data into an output bitstream and outputting the output bitstream via the display interface.

22. The data processing method of claim 21, wherein the display interface is a display serial interface (DSI) standardized by a Mobile Industry Processor Interface (MIPI) or an embedded display port (eDP) standardized by a Video Electronics Standards Association (VESA).

23. The data processing method of claim 21, wherein the compression characteristic is a compression ratio corresponding to the compressed display data.

24. The data processing method of claim 21, wherein the transmission setting of the output interface comprises a number of data lines enabled over the display interface.

25. The data processing method of claim 21, wherein the transmission setting of the output interface comprises an operating frequency of each data line.

26. The data processing method of claim 21, wherein the transmission setting of the output interface comprises a behavior of the output interface during a blanking period between adjacent data transmissions.

27. A data processing method comprising:
configuring a reception setting of an input interface over a display interface in response to at least a compression characteristic of a compressed display data; and
utilizing an input interface for receiving an input bitstream via the display interface, and un-packing the input bitstream into the compressed display data that is transmitted over the display interface.

28. The data processing method of claim 27, wherein the display interface is a display serial interface (DSI) standardized by a Mobile Industry Processor Interface (MIPI) or an embedded display port (eDP) standardized by a Video Electronics Standards Association (VESA).

29. The data processing method of claim 27, wherein the compression characteristic is a compression ratio corresponding to the compressed display data.

30. The data processing method of claim 27, wherein the reception setting of the input interface comprises a number of data lines enabled over the display interface.

31. The data processing method of claim 27, wherein the reception setting of the input interface comprises an operating frequency of each data line.

32. The data processing method of claim 27, wherein the reception setting of the input interface comprises a behavior of the input interface during a blanking period between adjacent data transmissions.
